(19) United States
(12) Patent Application Publication
(10) Pub. No.: US 2008/0022589 A1
(43) Pub. Date: Jan. 31, 2008

(54) Two-colored flower pot with an edge which looks like enamel

(76) Inventor: Desideri Fabrizio, Larciano (PT) C/O I.DE.L. S.R.L. (IT)

Correspondence Address: DONN K. HARMS;PATENT & TRADEMARK LAW CENTER, SUITE 100, 12702 VIA CORTINA, DEL MAR, CA, 92014, US

(21) Appl. No.: 11/881,417

(22) Filed: Jul. 27, 2007

(30) Foreign Application Priority Data
Jul. 28, 2006 (IT) PT 2006 U 000018

(51) Int. Cl. A01G 9/02; B29C 47/92

(52) U.S. Cl. 47/65.7; 264/40.4

(57) ABSTRACT

A device and method of production therefor yielding a two color or two finish flower pot formed in a single injection molding process using a single extrusion operation. The method and device yielded thereby providing pots with an upper cylindrical area colored or finished differently than a lower truncated portion of the pot.

This patent application claims priority to Italian patent application number PT 2006 U000018 filed on Jul. 28, 2006. The present device is a method and apparatus yielding a truncated cone flower pot with an edge like a cylindrical ring very similar in shape and dimension to a common terra cotta pot, except it is made out of plastic or of a recycled material. It is used to hold ornamental or flower plants with their own loam roots, and consists of a ring or upper cylindrical raised edge in one shiny color similar to enameling, and a truncated cone lower area of a different color. The unitary structure is all made in only one molding of a traditional type by presses provided with usual molds and an extruder used with simple means of multiple coloring.

According to present art various types of truncated cone pots are made, the most common ones being standard pots made with regenerated plastic material where plants are inserted with their root apparatus directly in the greenhouse to be later sent to commercial or retail centers. These pots, used only once, are usually colored in one color such as in black, brown or green and have a truncated cone shape or an upper cylindrical belt and a smaller conical one to provide for easier positioning into their containers which are needed for their transportation and stocking. For many years similar pots to those described herein made of traditional terra cotta have been used as decorations for windows, balconies and gardens and are often decorated or enameled to create a prettier appearance.

Many pots with various types of shapes and dimensions are molded and are usually made with plastic materials which look like traditional terra cotta pots possessing a terra cotta color. The device and method herein is that of a traditional conically shaped pot, but consists of two separate colors wherein the top of the pot is made up of a shiny colored cylindrical rim with a raised edge resembling an enamel. This can be obviously differentiated from standard pots made with plastic materials of a singular color and therefor represents a new object made at a reduced cost. The present pot is easily reusable with an important manufacturing quality of being molded in only one injection using traditional machinery possessing extruders and molds employing a component that the provides a proportioning device for two or more colors. The result can only be obtained by using a feeding system, and specific construction details of molds as disclosed herein. This is because conventional mixing/proportioning devices do not provide the ability to use to obtain pots of more than one color.

The use of these proportioning/mixing devices with the extruder, allows for the creation of two or more color streakings that provide “flaming” effects on molded units without creating areas of precise and continuous coloring and thus creates an interesting chromatic visual effect on the pots. In order to use these proportioning devices for two color pots it is necessary to create within the molds, an area of exact division between two, successively injected portions of differently colored plastic materials. The present device allows for this division area by providing a suitable “step” between the lower conical area of the pot and the cylindrical raised edge of the upper portion of the pot, which is similar in appearance to enamel. The step is located in an inconspicuous location which again provides for a separation of color between the cylindrical raised edge of the upper portion of the pot and the lower conical portion.

In addition to allowing for the differentiation of color with the previously described flaming effect, multi coloring can also be obtained by means of a series of geometric simplifications in conical area of the pot and by forming the water passage hole after pot molding is complete to avoid any problem of material flux that comes from extruder if the hole is formed in the conventional fashion during injection molding.

The enclosed figures are described as follows:

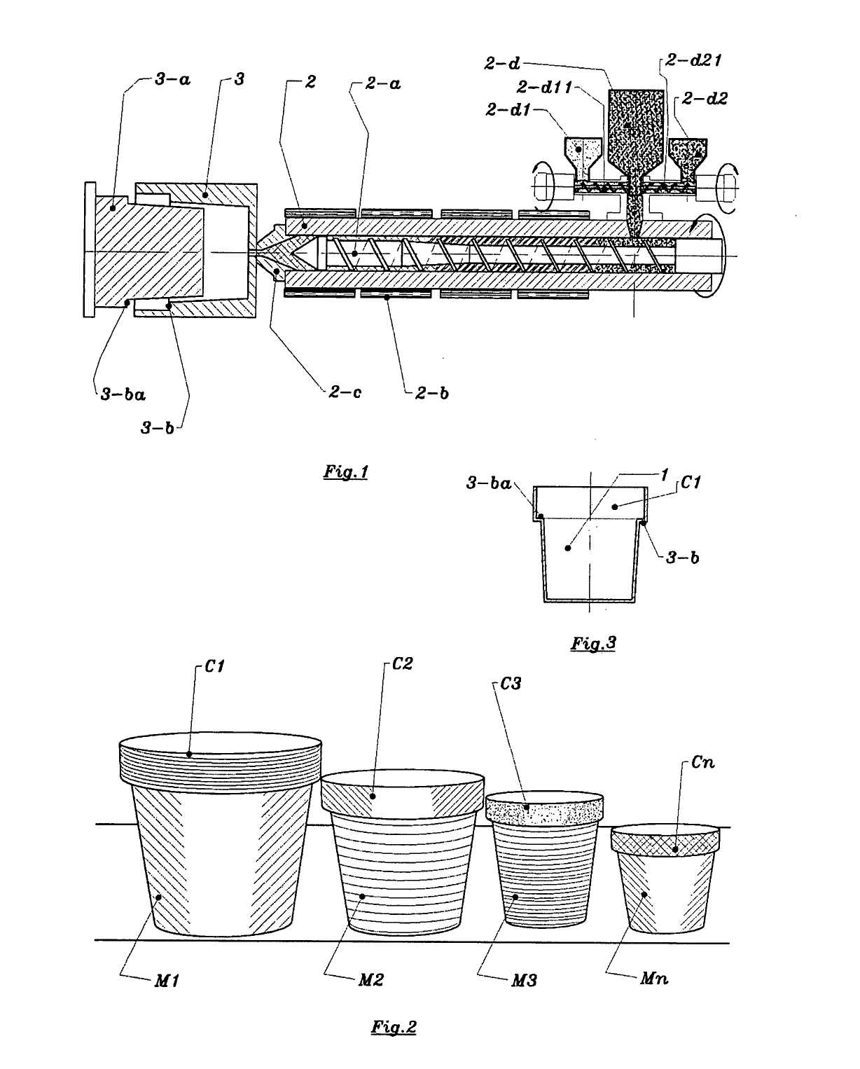

FIG. 1 shows a pot for flowers and plants similar to traditional terra cotta pots with a truncated cone shape in different sizes made with plastic or other synthetic materials. The lower portion of the pot, in the present device and method, is different in color than the enamel-like cylindrical raised edge of the top of the pot. The pot is created such that differently colored synthetic material is placed in the extruder and injected into the mold.

FIG. 2 shows a generic extruder or screw type extrusion head that allows for injection of plastic materials for molding, in this case, of pots for flowers and ornamental plants, as they are used in trade and in green housed for

Numeral 2-a shows a feeding screw for the material when it is in a liquid state typical of equipment normally used in moving and molding plastic material within specific molds located in front of head 2.
Numeral 2-b shows heating equipment made with a multitude of electrical resistance coils as a means for heating necessary to melt the plastic materials used in molding and contained in the extruder cylinder and moved by screw 2-a towards 2-c.
Numeral 2-c shows a nozzle for the plastic material injection located at molding point, there are many of these devices of various technical specifications and topologies.
Numeral 2-d shows a feed hopper for the plastic material still to be processed. Here the coloring material is inserted in order to obtain a final intensely colored product except in the rare case in which original granular material is inserted without any coloring material.
Numeral 2-d1 and 2-d2 show for the plastic material in which the granular plastic material from the feed hopper in FIG. 2-d is inserted and colored. In these figures two feed hoppers are used to create two-colored pots but more can be used to create the desired color

In FIG. 1, numerals 2-d11 and 2d-21 show screws for feeding and/or proportioning of the coloring materials contained in 2-d1 and 2-d2, these last ones are given in a non restrictive number. As shown in FIG. 1, the fixed half of the mold 3, has the characteristics of a conventional fixed half of the mold 3 that is usually connected to a press. The plastic material is injected into the female mold in which as shown depicts the connection area 3-b for separating and producing the truncated cone part of pot and upper ring portion which will be made in a different color according to the device and method herein. The removable or mobile half mold 3-a (in FIG. 1 and FIG. 3) has an annular ring of a substantially flat area 3-ba which goes to overlap 3-b mentioned in the fixed mold 3 portion. The planar annular engagement of the substantially planar connection area 3-b and flat area 3-ba of the fixed half of the mold 3 and mobile half of the mold 3-a combine to provide a separation area between the two different colored or finished sections where the plastic mix can change color or finish and cannot be seen in a compensating area connected between the lower truncated cone area M1-Mn, and upper ring C1-Cn, of different colors of the final produced pot according to the device and method herein.

In FIG. 2, numerals M1, M2, . . . Mn the truncated portions of show various sizes and dimensions of two-color flower pots that can be produced according to this invention which as can be seen would be made according to the mold dimensions. Also in FIG. 2, C1, C2, . . . Cn show the raised cylindrical ring portion of the upper portion of the pots having a different color than the lower truncated conical area of the lower portion of the pots so produced.

Upon examination of the enclosed figures it is quite easy to understand the object of the present device and method to make two color pots it by using equipments already in use for other various types of molding operations for single color pots.

FIG. 1 shows a molding production system for the creation of a two-color pot with a raised cylindrical edge which appears shiny in color or enamel-like.

Overall, shown here there is an extruder 2 including a feeding hopper (2-d) for uncolored (neutral) plastic granulate and two feeders (2-d1 and 2-d2) used as proportioning devices and mixers which provide a means to color the granular product (2-d) following an exact management system which is programmable both in quantity and time. The mixed product then moves through the screw (2-a) of the extruder 2 where the granulate, colored according to need, enters a liquid state and is propelled by the screw towards the injection nozzle (2-c) and into the mold 3 and 3a in the sequence and timed to provide the two desired colors.

Flower and plant pots are injected today using this method but the results are very different form those obtained in the presently described manufacturing method. Two-color containers are commonly obtained streaked along injection direction colonizing the entire pot. In previous methods the colored areas are not well differentiated as is the object of the present pot molding method, which provides for a well defined separation between the color of the larger lower truncated conical portion of the pot and the raised cylindrical edge of the top portion of the pot.

In order to obtain this separation of coloring two geometric characteristics of conical pot the flat ring area, formed between in the engaged mold halves 3 and 3-a shown by the planar annular areas 3-b and 3-ba operate to yield great proportioning precision of the colors on each side of the planar areas 3-b and 3-ba over conventionally injection molded terra cotta pots it was also possible to reduce, generally speaking, the difference between the two colors within the ring C1 portion, after having well made ring portion C1 with a shiny color and seemingly enameled, and the lower portion not. Also smaller base shows an exchange area of coloring because also here injection is going to be prepared for next coming ring or cylindrical belt C1 of a subsequently molded pot.

On the smaller base (flat bottom support portion) of truncated cone pot, coloring is not important, since it cannot be viewed when used as a pot for a plant. As a result, any excess injection material from the truncated cone portion of a prior molded pot, is mixed with incoming shiny material or alternately colored injection material for the ring C1-Cn on a subsequent molded pot, before the coloring is carried out between cone and next coming shiny ring C1-Cn which is enamalized or colonized differently than the truncated portion of the next pot. As can be readily seen, by exact timing of the screw (2a) moving the proper amount of mixture of materials for each single pot, from the two feeders (2d1 and 2-d2), and the timing of that volume and mixture delivered by the screw (2a) to the mold, the mixed material can be injection molded first in one color or shiny finish to the ring C1-Cn, and subsequently to form the truncated sidewall M1-Mn in the second color of finish. Any remaining material from the injector 2 that carries sidewall material and new incoming ring C1-Cn material, is deposited to form the bottom wall of the pot prior to the next subsequent pot being molded. The pots, as well shown in drawing of FIG. 2 are also made with extremely regular geometries and under a few linear points in order to keep feeding fluxes of the differently mixed melted plastic material without problems due to thickness changes or of section changes of manufactured items which is injected or also reinforcing linings.

As depicted in Figure the various and numerous shapes that can be made all with various cylindrical belts or rings C1, C2, . . . Cn, well colored which can resemble terra cotta flower pots with enameled edges or different colors.

We need now to point out that the shape and dimension of the area formed in molds 3 and 3a, in order to better allow change of color at the intersection of 3-ba and 3b, does not much differ from that of terra cotta pots and in any case it is not of a different shape from usual stocking areas for piling up usual terra cotta or plastic pots (black or brown).

Finally, we want to point out that dimensional changes both of belt C1-Cn and of truncated cone M1-Mn do not change various items here described in relation to present invention.

1. A method of injection molded flower pot, having two distinctly colonized portions, formed of plastic material molded by means of a press with a mold of a conventional screw type injection molding apparatus, in only one injection molding and generally with only one injection point, employing an extruder has a plurality of proportioning devices feeding a mixing device for mixing differently colonized granulate in a granulate stream from said proportioning devices and feeding the granulate stream to said injection molding apparatus, for injection into a mold to form a pot having a cylindrical upper edge with a first color or finish, and a truncated cone portion of a second color or finish, separated by a ring type flat area which acts as a demarcation between the two outside colors, that is a separation with the truncated cone area and which will generally works as a shoulder for stacking of said pots, in a single injection process, comprising the steps of:
ascertaining a volume of granulate which when heated will form said pot in said mold;
ascertaining a first portion of said granulate which will be required to form said upper edge;
ascertaining a second portion of said granulate which will be required to form said truncated cone portion;
employing one said proportioning and mixing devices to mix a first color or finish in said first portion said granulate stream to yield a first color or finish, to form said upper edge;
employing a second said proportioning and mixing device to mix said second portion of said granulate stream in a second color or finish to yield a second color or finish, to form said truncated cone portion;
heating said granulate stream to a liquid form and injecting it in a single injection under force and at a rate, into said mold from a first end;
timing delivery of said first portion of said granulate stream to form said upper edge;
timing delivery of said second portion of said granulate stream to form said truncated cone portion; and
removing said pot from said mold having said upper edge having a color or finish different from said truncated cone portion.

2. The method of claim one additionally comprising:
employing a screw type press and two or even more said proportioning devices for color and for a programmable mixing.

3. A flower pot formed by the method of claim 1 characterized by fact that said pot so produced has two areas with different colors, a cylindrical ring type, and a truncated cone type, said two colors separated between by a flat ring or shoulder portion traverse to said truncated cone which is employable for stacking, which forms an unseen separator between said two colors or finishes of the adjoining portions.

4. The flower pot of claim 3, provided with a bottom edge, similar to conventional terra cotta pots, just under cylindrical area, said bottom edge employable for stacking and engageable with conventional terra cotta pots or said flower pot of claim 3.

5. The flower pot of claim 3, characterized by the fact that it has said edge of a shiny color on said cylindrical ring and said truncated cone is colored in a darker color than said cylindrical ring to thereby better show difference.
